(19) United States
(12) Patent Application Publication
(10) Pub. No.: US 2015/0083264 A1
(43) Pub. Date: Mar. 26, 2015

(54) HYDROGEN TRANSFER TUBE

(71) Applicant: Hanil Tube Corporation, 689-3, Kyoung Seo-Dong Seo-Gu, 404-722 Incheon, Korea, Incheon (KR)

(72) Inventors: Seong-Hwa Choo, Incheon (KR); Byeong-Rok Na, Incheon (KR)

(21) Appl. No.: 14/493,868

(22) Filed: Sep. 23, 2014

(30) Foreign Application Priority Data
Sep. 24, 2013 (KR) 10-2013-0113255

(51) Int. Cl. F16L 9/12

(52) U.S. Cl. CPC F16L 9/123
USPC 138/140

(57) ABSTRACT

Disclosed is a hydrogen transfer tube, including: a first layer having elusion resistance to hydrogen; and a second layer surrounding an outer surface of the first layer, formed of polyurethane in order to prevent the permeation of hydrogen. In one form the hydrogen transfer tube includes at least one protective layer surrounding the first layer and second layer.

### CROSS-REFERENCE TO RELATED APPLICATIONS

This patent application claims priority pursuant to Title 35 USC §119 to Korean Patent Application No. 10-2013-0113255, filed Sep. 24, 2013, entitled “Hydrogen Transfer Tube,” the entire content of the specification, claims and drawings of which are hereby incorporated by reference as if fully set forth herein.

### BACKGROUND OF THE INVENTION

1. Field of the Invention

The present invention relates to a tube for transferring hydrogen. Specifically, the present invention relates to a tube for transferring hydrogen which is capable of safely supplying hydrogen to a hydrogen battery used in automobiles, ships, portable generators, and the like.

2. Description of the Prior Art

Due to environmental regulations applied to transportation fields and the depletion of carbon fuels, new methods for supplying electric power to automobiles, ships, and the like have been presented. These new methods may be thought to be the simplest in using electric power, but storing electric energy in transport vehicles is problematic. Known storage batteries are relatively heavy and have increased volumes, and cannot store sufficient amounts of energy for long distance travel.

Therefore, attempts are being made to substitute general storage batteries with fuel batteries. Fuel batteries employ the contrary principle of electrolysis. In general, electricity is generated by a chemical reaction of hydrogen as fuel and oxygen as an oxidant. The hydrogen is stored in a tank mounted in the transport vehicle. Hydrogen is transferred through a pipe made of steel which can withstand high temperatures (100° C. or higher) and high pressures (about 5 bar). The steel has an advantage of being substantially inactive with respect to hydrogen, and thus prevents the decomposition of the pipe due to hydrogen gas or the contamination of gas.

However, oxygen tends to deteriorate steel. Moreover, the steel pipe has problems in that it is heavy, is not flexible, and is expensive.

### SUMMARY OF THE INVENTION

The present invention has been made to solve the above-mentioned problems occurring in the prior art, and an aspect of the present invention is to provide a tube for transferring hydrogen, that is, a hydrogen transfer tube which can withstand high temperatures and high pressures and is flexible.

Another aspect of the present invention is to provide a hydrogen transfer tube which is durable even under low temperatures and high pressures as well as high temperatures and high pressures and is flexible.

In order to accomplish these objects, there is provided a hydrogen transfer tube, including: a first layer formed of a material having elusion resistance to hydrogen; and a second layer, as a separate layer surrounding an outer surface of the first layer, formed of polyurethane in order to prevent the permeation of hydrogen.

Here, a material of the first layer is a polyamide-based material.

The hydrogen transfer tube may further include a first protective layer disposed to surround the first layer and the second layer and providing shock resistance and heat resistance to the tube.

The first protective layer may be formed of a thermoplastic elastomer.

The hydrogen transfer tube may further include a second protective layer disposed to surround the first layer and the second layer and providing shock resistance and heat resistance to the tube.

The second protective layer may be formed of a thermoplastic elastomer.

The first protective layer may be disposed to surround an outer surface of the second protective layer.

### BRIEF DESCRIPTION OF THE DRAWING(S)

The above and other objects, features and advantages of the present invention will be more apparent from the following detailed description taken in conjunction with the accompanying drawing, in which:

FIG. 1 is a perspective view showing a hydrogen transfer tube composed of four layers according to an embodiment of the present invention.

### DETAILED DESCRIPTION OF THE PREFERRED EMBODIMENTS

Hereinafter, a hydrogen transfer tube 100 according to an embodiment of the present invention will be described. The hydrogen transfer tube described herein is exemplified as one that is used to transfer hydrogen fuel in an apparatus generating power by using the hydrogen fuel. For example, the hydrogen transfer tube 100 may serve as a supply pipe for supplying hydrogen fuel to a fuel battery in automobiles or ships driven by the hydrogen fuel. The hydrogen transfer tube 100 according to an embodiment of the present invention includes a first layer 110 and a second layer 120.

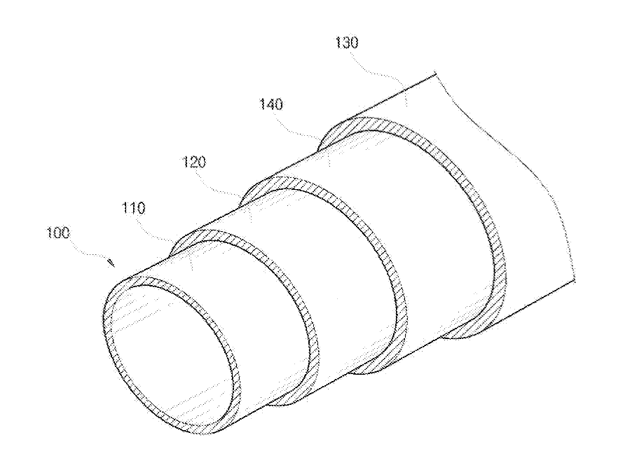

FIG. 1 is presented to illustrate the first layer 110 and the second layer constituting the hydrogen transfer tube 100. FIG. 1 is a perspective view showing a tube composed of multiple layers. FIG. 1 shows schematically a hydrogen transfer tube composed of a first layer and a second layer sequentially from the inside according to an embodiment of the present invention.

The first layer 110 forms a layer that is in direct contact with hydrogen flowing through the hydrogen transfer tube 100. Therefore, the first layer 110 is preferably formed of an elution-resistant material so as to prevent the contamination of hydrogen due to the elution of components constituting the first layer 110 into the hydrogen transfer tube 100. According to an embodiment, a material for the first layer 110 may be a polyamide-based material. A fluorinated material that is conventionally used has low permeability to alcohol, and has an advantage in that the eluted material thereof is less when the fluid is liquid than when the fluid is gas. However, when the fluid is gas like hydrogen, a polyamide-based material such as nylon has excellent elution resistance. The thickness of the first layer 110 may be appropriately changed according to the required durability and strength of the hydrogen transfer tube.

The second layer 120 forms a layer providing airtightness to the hydrogen transfer tube 100. A hydrogen gas molecule has the smallest volume and weight among molecules, and has a high probability of leaking, and has a high risk of exploding when it leaks. Therefore, the airtightness of the hydrogen transfer tube is of the most importance. The second layer 120 is preferably made of polyurethane in order to prevent the permeation of hydrogen. In conventional cases, polyurethane is used for an adhesive layer that attaches two layers to each other in a multi-layered tube. However, in the present hydrogen transfer tube 100, a polyurethane layer is provided as a separate layer having a predetermined thickness for airtightness. The second layer may have an appropriate thickness depending to the required durability, airtightness, and strength of the hydrogen transfer tube 100.

According to an embodiment of the present invention, the hydrogen transfer tube 100 may further include a first protective layer 130.

FIG. 1 shows the hydrogen transfer tube 100 including the first layer 110, the second layer 120, and the first protective layer 130 according to an embodiment of the present invention. Referring to FIG. 1, the first protective layer 130 is formed to surround the first layer 110 and the second layer 120. The first protective layer 130 provides shock resistance and heat resistance (flame retardancy) to the hydrogen transfer tube 100. That is, the first protective layer 130 enhances physical durability to the hydrogen transfer tube 100, and, due to the placement of the first protective layer 130, the hydrogen transfer tube 100, for example, can withstand at a high temperature of 115° C. or a low temperature of −40° C. and can withstand a shock applied from the outside. The excellent physical durability of the hydrogen transfer tube 100 provides advantages when an automobile or a ship equipped with the hydrogen transfer tube 100 is used in a desert, tropical, cold, or polar region, or when the hydrogen transfer tube 100 is equipped on a bottom surface of an automobile and small stones may bounce up during traveling. According to an embodiment, the first protective layer 130 is preferably formed of a thermoplastic elastomer.

According to an embodiment of the present invention, the hydrogen transfer tube 100 may further include a second protective layer 140.

FIG. 1 shows the hydrogen transfer tube 100 including the first layer 110, the second layer 120, the first protective layer 130, and the second protective layer 140 according to an embodiment of the present invention. Referring to FIG. 1, the second protective layer 140 is formed to surround the first layer 110 and the second layer 120. The second protective layer 140 provides chemical resistance to the hydrogen transfer tube 100. That is, the second protective layer 140 enhances durability against chemical shocks applied to the hydrogen transfer tube 100 from the outside. Due to the placement of the second protective layer 140, the hydrogen transfer tube 100, for example, can withstand a high pressure of 10 bar or higher, and can be prevented from deteriorating due to materials entering from the outside. According to an embodiment, the second protective layer 140 is preferably formed of a polyester-based material. Further, according to an embodiment, the second protective layer 140 is preferably formed inside the first protective layer 130.

Hereinafter, performance test results of the hydrogen transfer tube according to an embodiment of the present invention are presented.

Hydrogen Leak Test

Test was conducted as follows.

1) A 1/2″ tube is installed.

2) Hydrogen (purity: 99%) is applied (20 barg) to perform soaking for 4 hours for each temperature (25° C. room temperature, −40° C. low temperature, and 115° C. high temperature).

3) After the soaking, the pressure change over 1 hour is checked.

4) The pressure change is used to verify the amount of hydrogen that leaked and the deformation of the tube.

The test results indicated that the pressure change did not occur due to the maintenance of airtightness and the amount of hydrogen leaked was less than the standard value.

The standard value may be the European standard (EC406) or an individual standard value from the final manufacturer of an OEM vehicle or the like.

The present test verified that the hydrogen transfer tube according to an embodiment of the present invention had a more excellent effect than the existing tubes for mass production in light of permeation resistance according to the temperature change at room temperature, low temperature, and high temperature.

Burst Pressure Evaluation

The burst pressure is required to be 60 barg or higher.

Test results were as follows.

TABLE 1

| | Classification | | |
|---|---|---|---|
| | Room temperature | Low temperature | High temperature |
| | (25° C.) | (−40° C.) | (115° C.) |
| Burst | 190 barg | 190 barg | 120 barg |
| pressure | | | |
| (barg) | | | |

Table 1 shows that the burst pressure of the hydrogen transfer tube according to an embodiment of the present invention was three times or higher in room temperature and the low temperature and two times or higher in the high temperature, as compared with the required burst pressure.

It can be seen from the present test that the hydrogen transfer tube according to an embodiment of the present invention had a more excellent effect than the existing tubes for mass production in light of permeation resistance according to the temperature change in the burst pressure test at room temperature, low temperature, and high temperature.

Pressure Circulation Evaluation

The purpose of the pressure circulation evaluation is to verify the deformation of a product and the maintenance of airtightness when the test is conducted under extreme conditions of repetitive circulation evaluation. The test was conducted for 100,000 cycles at 1 cycle per 10 seconds at the minimum pressure of 5 barg and the maximum pressure of 20 barg.

The following is about specific pressures in the test cycles.

TABLE 2

| Pressure maintenance | Applied pressure |
|---|---|
| time (s) | (barg) |
| 0~1 | 0 |
| 2~3 | 5 |
| 4~6 | 20 |
| 7~8 | 5 |
| 9~10 | 0 |

Test results were as follows.

TABLE 3

| | Room temperature | Low temperature | High temperature |
|---|---|---|---|
| | (25° C.) | (−40° C.) | (115° C.) |
| Deformed or | No | No | No |
| Not | | | |

Table 3 shows that the hydrogen transfer tube according to an embodiment of the present invention was not deformed even at the pressure circulation test of 100,000 cycles at room temperature, low temperature, and high temperature.

After the pressure circulation test, the hydrogen leak test and the burst pressure test were conducted in order to check the deformation of a product and the maintenance of airtightness. Test results were as follows.

TABLE 4

| | Room temperature | Low temperature | High temperature |
|---|---|---|---|
| | (25° C.) | (−40° C.) | (115° C.) |
| Amount of | None | None | None |
| hydrogen | | | |
| leaked | | | |
| Burst | 180 barg | 180 barg | 120 barg |
| pressure | | | |
| (barg) | | | |

Table 4 shows that, from the present pressure circulation test, as for the hydrogen transfer tube according to an embodiment of the present invention, the amount of hydrogen leaked was not abnormal at room temperature, low temperature, and high temperature, and the burst pressure was three times in room temperature and the low temperature and two times in the high temperature as compared with the burst pressure (60 barg) required in the burst pressure test. Therefore, the hydrogen transfer tube according to an embodiment of the present invention was excellent in effects depending on the temperature change and the pressure change as compared with the tube for mass production.

Pressure/Vibration/Temperature Test

The pressure/vibration/temperature (PVT) test is a comprehensive performance evaluation with respect to pressure, vibration, and temperature, and is conducted for 14 days at 1 cycle per day at respective temperatures. After the PVT test, the hydrogen leak test and the burst pressure test were sequentially conducted.

Test results were as follows.

TABLE 5

| | Room temperature | Low temperature | High temperature |
|---|---|---|---|
| | (25° C.) | (−40° C.) | (115° C.) |
| Amount of | None | None | None |
| hydrogen | | | |
| leaked | | | |
| Burst | 180 barg | 180 barg | 120 barg |
| pressure | | | |
| (barg) | | | |

Table 5 shows that, after the PVT test of 14 cycles at room temperature, low temperature, and high temperature, as for the hydrogen transfer tube according to an embodiment of the present invention, the amount of hydrogen leaked was not abnormal at room temperature, low temperature, and high temperature, and the burst pressure was three times in room temperature and the low temperature and two times in the high temperature as compared with the burst pressure (60 barg) required in the burst pressure test. It can be seen from the present test that, in the hydrogen leak test and the burst pressure test at room temperature, low temperature, and high temperature, the hydrogen transfer tube according to an embodiment of the present invention was excellent in effects depending on the temperature change and the pressure change as compared with the tube for mass production.

Although preferable embodiments of the present invention have been mainly described, various changes can be made within the scope of the invention described in the accompanying claims.

What is claimed is:

1. A hydrogen transfer tube, comprising:
a first layer formed of a material having elusion resistance to hydrogen; and
a second layer surrounding an outer surface of the first layer, formed of polyurethane in order to prevent the permeation of hydrogen.

2. The hydrogen transfer tube of claim 1, wherein a material of the first layer is a polyamide-based material.

3. The hydrogen transfer tube of claim 1, further comprising a first protective layer disposed to surround the first layer and the second layer and providing shock resistance and heat resistance to the tube.

4. The hydrogen transfer tube of claim 3, wherein the first protective layer is formed of a thermoplastic elastomer.

5. The hydrogen transfer tube of claim 3, further comprising a second protective layer disposed to surround the first layer and the second layer and providing chemical resistance to the tube.

6. The hydrogen transfer tube of claim 5, wherein the second protective layer is formed of a polyester-based material.

7. The hydrogen transfer tube of claim 5, wherein the first protective layer is disposed to surround an outer surface of the second protective layer.
